(19) United States
(12) Patent Application Publication
(10) Pub. No.: US 2002/0021306 A1
(43) Pub. Date: Feb. 21, 2002

(54) Method for allocating operator control functions to operator-communication controls of an electronic device which is able to execute the functions of a plurality of electronic devices as switchable functions, especially devices in motor vehicle luxury feature electronics, and the corresponding device

(76) Inventors: Helmar-Steffen Gehrke, Eberdingen/hochdorf (DE); Clemens Guenther, Ettlingen (DE)

Correspondence Address: KENYON & KENYON, One Broadway, New York, NY, 10004, US

(21) Appl. No.: 09/873,444

(22) Filed: Jun. 4, 2001

(30) Foreign Application Priority Data
May 30, 2000 (DE) 1 00 26 760.2-34

(51) Int. Cl. G09G 5/00

(52) U.S. Cl. 345/716

(57) ABSTRACT

A method and a device for producing simpler operability of a plurality of devices. Using operating symbols is proposed, which are known to practically everybody, for operating the most important functions of a device. Thus, certain operating symbols are used, which are well known for a predetermined type of device and are dedicated to certain original functions of this type of device, and also for operating synonymous functions in devices of completely different types. This brings along the advantage that technically basically different devices can be uniformly operated in practice, without having to learn a new set of symbols.

### BACKGROUND INFORMATION

Though applicable to any electronic device, the present invention as well as the problem on which it is based are explained with regard to an on-board operating system of an automobile for on-board luxury feature electronic devices of an automobile.

The development of electronically working devices on board of automobiles is rapid. A plurality of devices can be operated by the driver either manually, partially automated or fully automated. Here are some examples: an air conditioning system, an automatic climate control system, a heating system, a ventilating system, a tempomat (driving speed control), a navigational system, an automobile telephone, a traffic information system, a television unit, a radio unit, a cassette unit, a CD player, just to name some of those devices.

If the control of such devices is done automatically, the driver does not have to concern himself with the operating details. Automatic climate control is cited as an example, in which the driver simply sets a selected temperature and the automatic climate control does the rest, that is, it controls the air conditioning system in such a way that the selected temperature is reached relatively fast.

Admittedly, most devices cannot be operated completely automatically. That lies in the nature of the function fulfilled by the device. For example, a navigational system offers a plurality of useful functions which cannot proceed automatically, but with which it makes more sense for the driver to call them up in a targeted manner. An example of this is repeating the last status message of the vehicle navigational system, or acoustically announcing once more the next turn-off point from the road currently being traveled.

The more technical devices depend on the driver for useful operation, the more important it is to relieve the driver of “thinking work”.

The devices named as examples above, available in the current state of the art, have a multitude of different operating symbols printed upon certain keys, paddle controllers or other operating elements, with which they make clear to the driver the technical function to be executed by operating the particular switch or key. The DIN symbols used in the state of the art are assigned on the principle of representing the respective technical function by a symbol that is as common as possible, and that means internationally understood. However, this transposition—representation of the technical function by a commonly understood symbol—is only seldom successful.

The result is that, with the increasing number of devices, in operating these devices, the driver finds himself quickly overtaxed, because he has to remember too many symbols, which can really hinder him in devoting his entire attention to traffic.

European Patent No. 0 925 989 A2 looks at another problem which, however, is connected with the multitude of operating symbols on account of the multitude of different technical devices: There, the so-called softkey technology is described: There is a limited number of operating keys within an on-board operating console, which are used to operate a multitude of technical devices, but here another way is described. For, the operating keys suggested there do not have a uniform, constant inscription, but the inscription changes, depending on which device is just being switched actively into service. By doing this, to be sure, certain keys or paddles can be saved, but that does not stop the confusion due to the multitude of symbols.

### SUMMARY OF THE INVENTION

The method according to the present invention and the corresponding device according to the present invention, as compared to known approaches, have the advantage that an operator of a multitude of devices does not keep having to learn new symbols.

A concept at the basis of the present invention is to use such operating symbols for operating the most important functions of a device, which everybody knows. This goes back to the realization that indeed, many technical devices can be operated sensibly by a few basic functions, which differ hardly at all in their operation, even though the devices themselves are of a totally different technical nature. Thus, operating symbols, well known for a predetermined type of device, and dedicated to certain original functions of this type, are also used for operating synonymous functions in devices of a totally different kind.

This brings along the advantage that technically basically different devices can be uniformly operated practice, without a need to learn a new set of symbols. A further advantage is that, when the number of keys basically suggested for operation is not too great, for example five, the five most important functions of the device are immediately suggested to the user, so that the less important functions of the device are separated from the important functions of the operating system. The user is thereby relieved of having to think about differentiating between important and “unimportant” functions (in the sense of functions forming certain extras). Especially with regard to the huge technical functional multiplicity of some devices, this represents a considerable advantage.

According to one preferred further refinement, the operating symbols used derive from the audio area, especially from operating a CD player: The play symbol, the stop symbol, the pause symbol, the skip forwards symbol, the skip backwards symbol, as well as the optional symbols forward and backward are used. Even a targeted selection from these symbols can be sufficient, depending on the plurality of technical devices to be controlled, for the purpose of attaining the above-mentioned advantages.

In practice, to the play symbol there is mostly assigned the function “activate the device, so that one can enjoy it”, to the stop symbols the opposite, namely, the deactivation is assigned, to the pause symbol is assigned mostly a temporary, easily reversible deactivation, or, depending on the technical device, another specific function.

The skip forwards symbol, as well as its reverse, the skip backwards symbol, can, for instance, be used for the operator selection of the next station for a video device or a radio, or, respectively, for the operator selection of the previous station. In the control of a CD player, the symbol refers to the next or the previous track. In the operation of a traffic information system, however, the two above-mentioned symbols could refer to the previous traffic status message report or to the next status message report, respectively. This takes advantage of the fact that many important bulletins are indeed presented serially to the user. In a vehicle navigation system, for example, the last announcement can be repeated, using the skip backwards key, and the next turn-off point can be announced acoustically once more, using the skip forwards key. In a vehicle speed control, the preselected speed can be raised, using the skip forwards key, and, using the skip backwards key, the opposite, namely, the speed can be lowered.

As can be seen just from these relatively arbitrarily picked examples, this fundamental choice of operating symbols is already quite suitable for carrying out the most important operating functions of a device. This is owing to the succinct character of the symbol and the easy identification with the assigned basic function: On/off/brief off/lower anything/raise anything.

The present invention can also be incorporated in an operating console for operating the previously mentioned plurality of devices, and if it is designed as a separately mounted operating console, it preferably contains a selector switch for selecting a certain device, a display for representing the device just selected as well as the previously mentioned keys. Such an operating console can then preferably be mounted at a point that is ergonomically easy to reach, such as in the middle console.

According to a further preferred refinement of this operating console, however, individual parts of it can also be integrated into the steering wheel of a vehicle. The above-mentioned selector switch may be suitable for this, as well as the keys marked with the universal symbols. The display, to be sure, can also be accommodated in the steering wheel, but for reasons of driving safety it is recommended that the display be mounted higher in the driver's field of vision, in order not to divert his glance too much from the road.

It is fundamental to the present inventive concept that it can be broadened to the extent that a certain limited number of additional keys are made available, which, however, preferably appear recognizably separate to the driver, in order to make further special functions of different devices operable, without impairing the simplicity of the present concept. Then such additional keys can be present either on the previously mentioned operating console, or alternatively, or redundantly, even at the device itself, provided it is accessible to the driver for operation.

### BRIEF DESCRIPTION OF THE DRAWINGS

FIG. 1 shows a basic version of an operating console using the general meaning of the five illustrated keys.

FIG. 2 through FIG. 10 show the operating console represented neutrally in FIG. 1 for use in the operation of nine different devices occurring in an automobile, as well as the meaning of the key specifically for each device.

FIG. 11 shows a possible steering wheel keyboard layout having keys for selecting a device as well as the above-mentioned five operating keys.

### DETAILED DESCRIPTION

In the figures, the same reference numerals denote the same or functionally the same component parts.

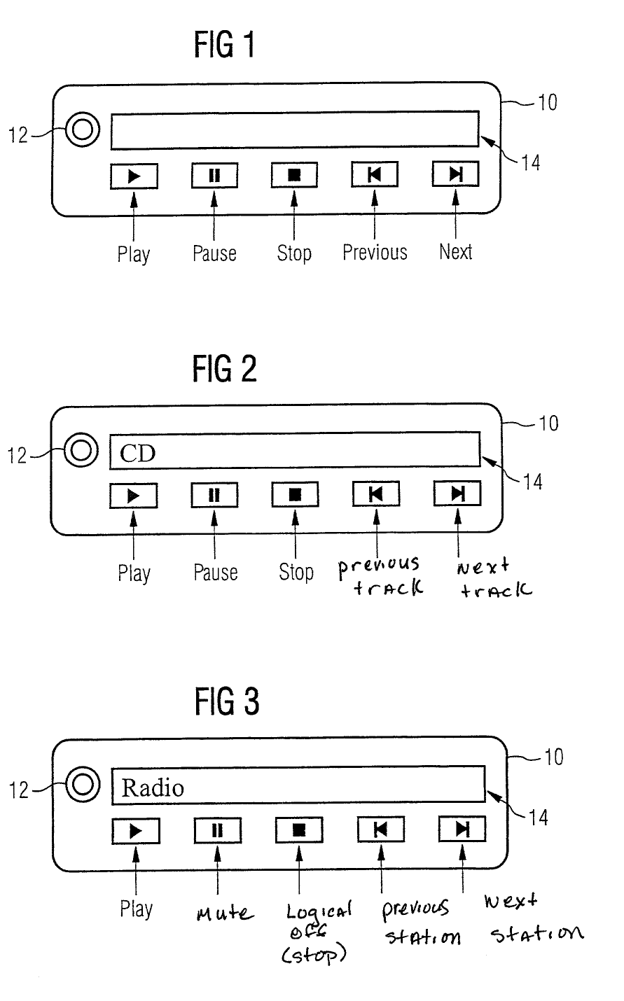

FIG. 1 shows a basic version of an operating console having the general meaning of the five illustrated keys.

The operating console shown in FIG. 1 is a separate, independent little device, having approximately the dimensions of the frontage such as can be seen in a CD player. Drawn in at the left is a rotary button acting as a rotary switch, which activates, i.e. selects, the control of various technical devices according to the rotary position set. In a certain, firm setting of the rotary switch, therefore, always just one device can be controlled.

Extending to the right next to the rotary switch an alphanumeric display 14 is provided. This indicates the actually selected device as text, and, optionally, further information relevant to the operating context. If it is the radio that just happens to be controlled at the moment, the currently set station's name and/or its frequency could be displayed, depending on the available display capacity. Furthermore, a reference symbol can be displayed, to point out the existence of additional operating functions which can be controlled with the above-mentioned, separate operating keys that do not appear on the operating console shown in FIGS. 1 to 11.

Furthermore, the above-mentioned five keys for representing each of the basic technical functions of the individual technical devices are illustrated in a row. Preferably there are used, as the basic set, the triangle all the way to the left, which points to the right with one apex; furthermore, the pause symbol, second from left, which reads two parallel, vertical lines; furthermore the stop symbol, in the middle, which is essentially arrived at by imaging a square which can be present with or without filling in the area; as well as the “previous” or skip backwards symbol, second from the right, which includes a vertical line having an adjoining horizontal line and a triangle pointing left, as well as the “next” or skip forwards symbol, all the way to the right, which points to the right as a mirror image of the previous symbol.

FIG. 2 shows the operating console depicted in FIG. 1, when the rotary switch 12 is set in such a way that the CD player in the automobile is actively controllable. In that case, the meanings of the key symbols are the way everybody knows them. From left to right: Play, pause, stop, previous track, play next track of the inserted CD.

FIG. 3 illustrates the control of a radio. As seen from left to right, preferably the following functions are covered: Play, mute, off, previous station, next station.

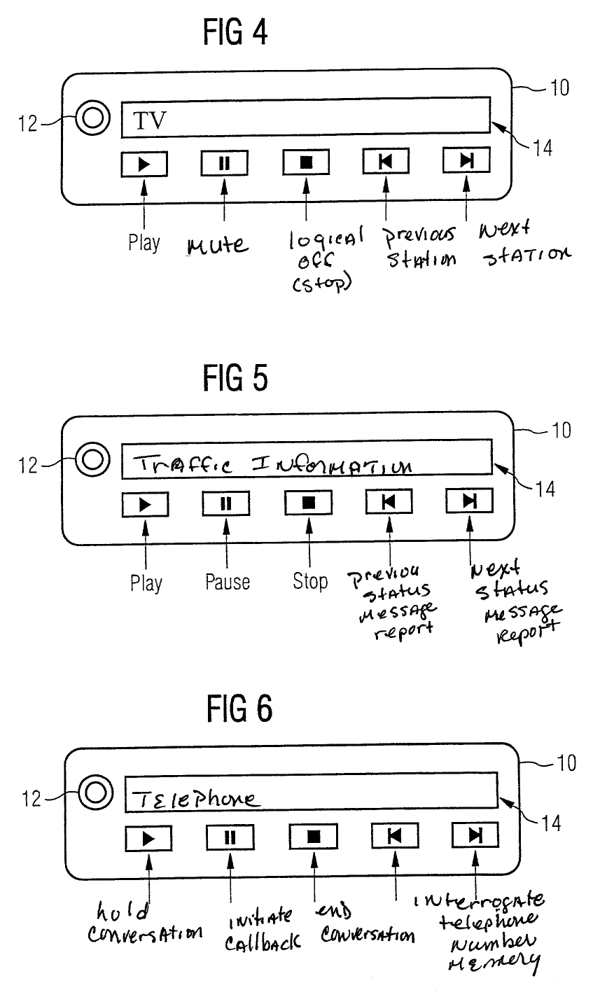

In FIG. 4 the corresponding functions for a television unit can be controlled.

FIG. 5 illustrates the control of a traffic information system. Here, from left to right, the following functions can be controlled: Play, pause, stop, indication or announcement of the previous status message report, as well as indication or announcement of the next status message report, if it can be assumed, that a certain predefined sequence of traffic information status message reports is present in the system's memory.

FIG. 6 illustrates the control of a telephone. Here, the play key can be used for having a conversation, that means, for dialing an input telephone number. For this, the telephone number can be available in a telephone number memory which can be interrogated by the skip forwards and skip backwards keys lying to the right.

For example, it might be possible to enter a telephone number using another numerical input device already present in the automobile, if it has a corresponding logical or physical connection to the operating console suggested here. Alternatively, there could also be available a connection to a mobile telephone, which could then, on its part, be used for inputting the telephone number.

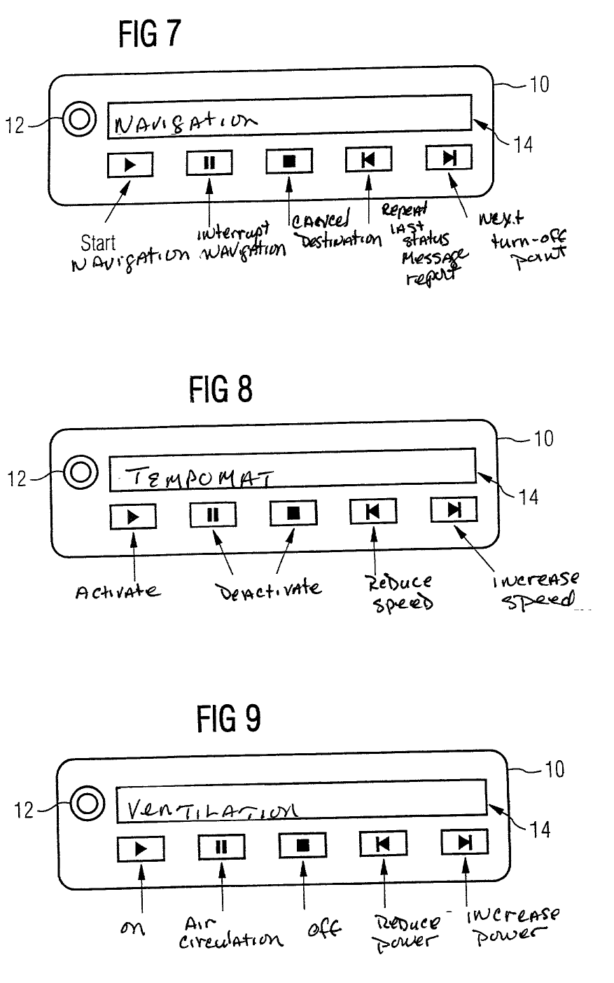

FIG. 7 illustrates the control of a navigation system. Here, the most important basic functions are starting navigation, which is controlled using the play key. The pause key is used preferably for temporarily interrupting navigation. The stop key is used to cancel a previously entered destination. The skip backwards key can preferably be used to repeat the last status message report given out by the navigation system, and the skip backwards key can preferably be used to announce or indicate the next turn-off point from the currently traveled road, or both.

FIG. 8 illustrates the control of a vehicle-speed control. Here the play key is used for activating the vehicle-speed control, the pause key for deactivating it and also the stop key. The skip backwards key is used for setting a lower preset speed, and the skip forwards key is used for the opposite, namely, to set a higher preset speed.

FIG. 9 illustrates the control of a ventilation system. The play key is used for switching on, the pause key is used for temporary air circulation control, that is, a purely internal circulation inside the automobile, the stop key is used for switching off, and the skip backwards key is used for reducing the ventilator power. The skip forwards key is used for increasing the ventilator power.

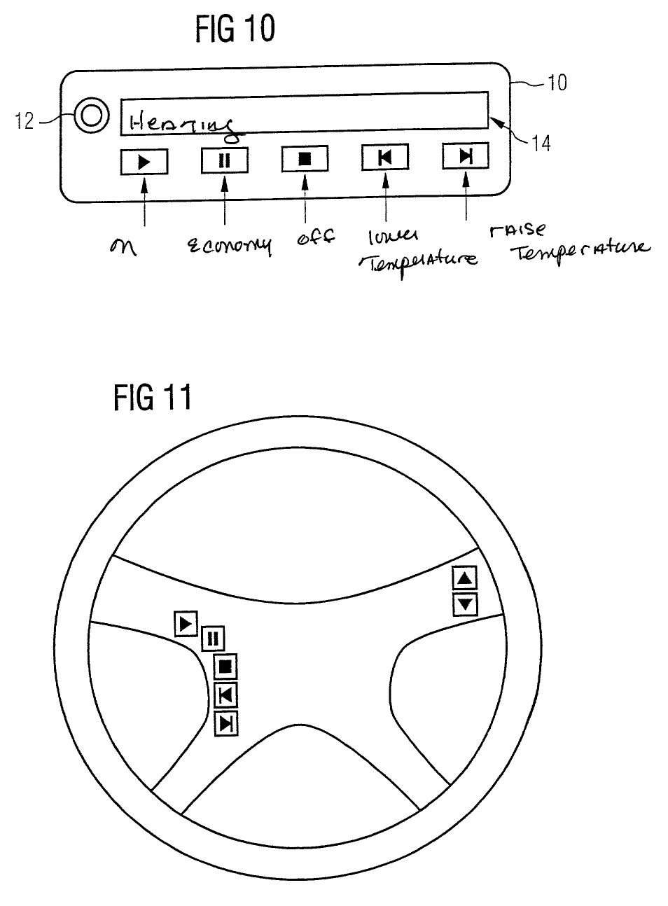

FIG. 10 illustrates the control of a heating system. The play key is used for switching on the heating system, the pause key can be used for an “economy” function, the stop key is used for switching off, the skip backwards key is used for reaching a lower temperature and the skip forwards key is used to reach a higher temperature. An automatic climate control system could be controlled in the same way, and here the skip forwards and skip backwards keys would be connected to different temperature numbers, then indicated on the display.

FIG. 11 shows a possible steering wheel keyboard layout having keys for selecting a device as well as the above-mentioned five operating keys.

In the broad spoke extending to the right, the illustrated steering wheel shows two press keys which assume the function of the rotary button 12 in FIG. 1. Thus any respective menu point in the backing selection menu can be started up by pressing the arrow key. Preferably, this backing menu is also illustrated rotatingly, so that a continual pressing of one of the two arrow keys would sometime lead again to the selection of a menu function that has already been started.

In the left region of the steering wheel, the above-mentioned five keys are shown arranged next to one another. It is self-explanatory that the geometric shape of the positioning can be arranged differently, so that an alternative, ergonomically favorable operation by the driver can take place. However, it seems sensible, and therefore preferred, to activate the selection keys 12′ with one hand and the actual operating keys with the other hand.

Although the present invention was described above with reference to a preferred embodiment, it is not limited to that but instead can be modified in a variety of ways.

For example, the proposed inventive concept can be meaningfully broadened by the integration of one or a small number of further keys. The key symbols “double arrow right” or “double arrow left”, which are well known as being used for fast forward winding and fast backwards winding in a cassette recorder can be integrated into the present inventive operating concept, to the extent that the technical functions of one or more of the devices to be controlled make it seem sensible. This would have the advantage that these key symbols likewise have an outstanding degree of recognition.

It goes without saying that additional symbols originating with other fields can also be used to substitute for one or the other key symbol in the proposed operating concept. Added for this purpose would be such as the plus symbol, the minus symbol, the circle in its meaning as zero or as a neutral element.

The operating concept could likewise be meaningfully broadened by YES keys or NO keys, when the operation of a device is so complicated that it seems to make sense to bring up on the display certain program-controlled questions which the user can then answer by pressing one of the above-named Yes/No keys, thereby operating the device in a corresponding manner.

What is claimed is:

1. A method for allocating operating control functions to operating-communications controls of an electronic device which is capable of executing functions of a plurality of electronic devices as switchable functions, the method comprising:
making available a predetermined number of operator controls assigned to respective operating functions of a first device type;
assigning respective operating functions of each further type of device to the operator controls; and
switching over the device among various device types, the operating functions of the operator controls being changed corresponding to the assignment.

2. The method according to claim 1, further comprising characterizing the operator controls using at least one of the following symbols from an audio field: a play symbol, a stop symbol, a pause symbol, a skip forwards symbol, a skip backwards symbol, a double arrow left, and a double arrow right.

3. The method according to claim 1, wherein the types of devices include at least one of the following types: a radio set, a television set, a traffic information system, a telephone, a navigation system, a vehicle-speed control, an air circulating system, a heating system and an air conditioning.

4. The method according to claim 1, wherein the electronic devices are devices in motor vehicle luxury feature electronics.

5. A device comprising:
a switching device for switching the device among various device types;
an assignment changing device for changing operator functions of operator controls changed with respect to assignments;
a display for indicating a type of device and corresponding operating function parameters; and
operator controls in the form of keys.

6. The device according to claim 5, wherein the device is an operating console at least partially integrated into a steering wheel.
